(19) United States
(12) Patent Application Publication
(10) Pub. No.: US 2005/0273428 A1
(43) Pub. Date: Dec. 8, 2005

(54) System and method for redirecting charges

(75) Inventor: David W. Baumert, Sammamish, WA (US)

Correspondence Address: SHOOK, HARDY & BACON L.L.P., 2555 GRAND BOULEVARD, KANSAS CITY, MO, 64108-2613, US

(73) Assignee: Microsoft Corporation, Redmond, WA (US)

(21) Appl. No.: 10/862,568

(22) Filed: Jun. 8, 2004

(51) Int. Cl. G06F 17/60

(52) U.S. Cl. 705/40

(57) ABSTRACT

A system and method are provided for enabling charge redirection for use of a service offered through a local platform, the local platform including a logon module having a charge redirection option selectable by a local platform user. The system includes a logon dialog module for corresponding with the local platform to enable the local platform user to select a charge redirection option and a digital voucher transmission component for transmitting a digital voucher from a remote service to the local platform to facilitate redirection of charges. The system additionally includes a bill processing module for processing a bill returned with the voucher to the remote service from the local platform.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to redirection of charges for use of computer services. In particular, embodiments of the invention relate to accessing a remote service to redirect charges incurred through a local platform.

### BACKGROUND OF THE INVENTION

Generally, in current computing environments, costs incurred for use of online services or network usage are charged to the owner of the client computer or local computer platform incurring the charges. However, situations exist in which a computer user is borrowing some combination of client hardware, client applications, or network connections from the client or owner of the local computer or platform. Such situations include those in which network connectivity is metered or user access to online information services is provided on a price-per-use basis. In these situations, the local computer user may want to assume responsibility or transfer responsibility away from the local computer platform to a designated party for any resulting incremental charges.

No convenient technique exists for redirecting charges from the client computer to the distant end or to another designated party. Accordingly, a technique is needed for allowing a user to redirect charges in a reliable and efficient manner upon user logon. As a distributed platform feature, the ability to direct these charges will differentiate one platform from another. An ability to support charge redirection will add unique value to a platform.

### BRIEF SUMMARY OF THE INVENTION

Embodiments of the present invention are directed to a method for using a remote service for redirecting costs for use of computer services on a local platform. The method includes receiving a user selection of a charge redirection option from the local platform and transmitting a voucher to the local platform for a verified user. The voucher facilitates payment of costs for verified user charges associated with the verified user consumption of services for the local platform. The method additionally includes receiving and processing a bill for verified user consumption of services from the local platform.

In yet a further aspect of the invention, a method is provided for implementing a remote service for directing costs associated with use of a service offered through a local platform. The local platform includes a logon module having a charge redirection option selectable by a local platform user. The method includes receiving a user logon including selection of a charge redirection option and processing user credentials using the remote service. The method additionally includes transmitting a voucher from the remote service to the local platform if the user credentials are approved. The method also includes tabulating a cost for service usage from the local platform for the approved user and forwarding the cost to the remote service. The remote service authenticates and pays the cost for the approved user if the cost is authenticated.

In yet a further aspect of the invention, a system is provided for enabling charge redirection for use of a service offered through a local platform, the local platform including a logon module having a charge redirection option selectable by a local platform user. The system includes a logon dialog module for corresponding with the local platform to enable the local platform user to select a charge redirection option and a digital voucher transmission component for transmitting a digital voucher from the remote service to the local platform to facilitate redirection of charges. The system additionally includes a bill processing module for processing a bill returned with the voucher from the local platform.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is a block diagram illustrating a computerized environment in which embodiments of the invention may be implemented;

FIG. 3 is a block diagram illustrating a charge redirection logon module in accordance with an embodiment of the invention;

FIG. 4 is a block diagram illustrating a remote service in accordance with an embodiment of the invention;

FIG. 5 is a flow chart illustrating a method in accordance with an embodiment of the invention; and

FIG. 6 illustrates a logon screen for a logon module in accordance with an embodiment of the invention.

### DETAILED DESCRIPTION OF THE INVENTION

I. System Overview

Embodiments of the invention include a method and system for redirecting usage charges from a local platform. A visiting user of the local platform preferably has a relationship with a bill-paying entity that subscribes to a remote service. The owner of the local platform also subscribes to the remote service and thus provides a logon dialog for communication between the user and the remote service. As will be further explained below, the remote service facilitates redirection of charges from the local platform to another bill paying entity or participant. The participant may be a service provider that the user accesses or any other participant willing to accept responsibility for charges.

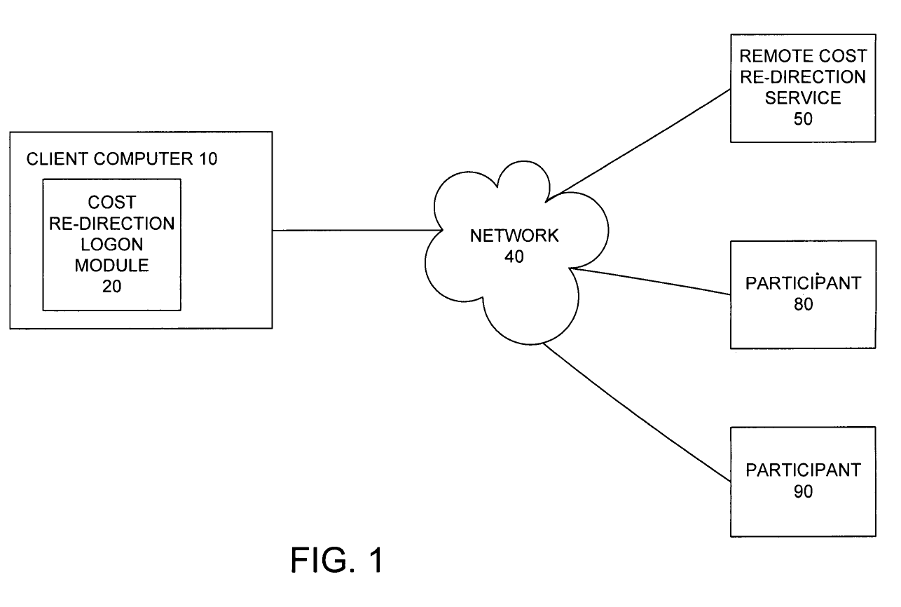

FIG. 1 illustrates a system for redirecting charges in accordance with an embodiment of the invention. A client computer 10 includes a cost redirection logon module 20. The client computer 10 communicates over a network 40 with a remote cost redirection service 50 and any number of participants 50, 90. Upon accessing the logon module 20, the user communicates over the network 40 with the remote cost redirection service 50 in order to direct the charges to an appropriate participant 50, 90. The logon module 20 provides a charge redirection option to the user. If the user opts for a charge redirection logon, the preference is communicated along with the user's logon credentials through completion of a logon dialog between the cost redirection logon module 20 and the remote cost redirection service 50. Together, the logon module 20 and the remote cost redirection service 50 process billing redirection for use in cases where a local computer is borrowing some combination of client hardware, client applications, or network connections from another party and intends to assume responsibility for any resulting incremental charges.

II. Exemplary Operating Environment

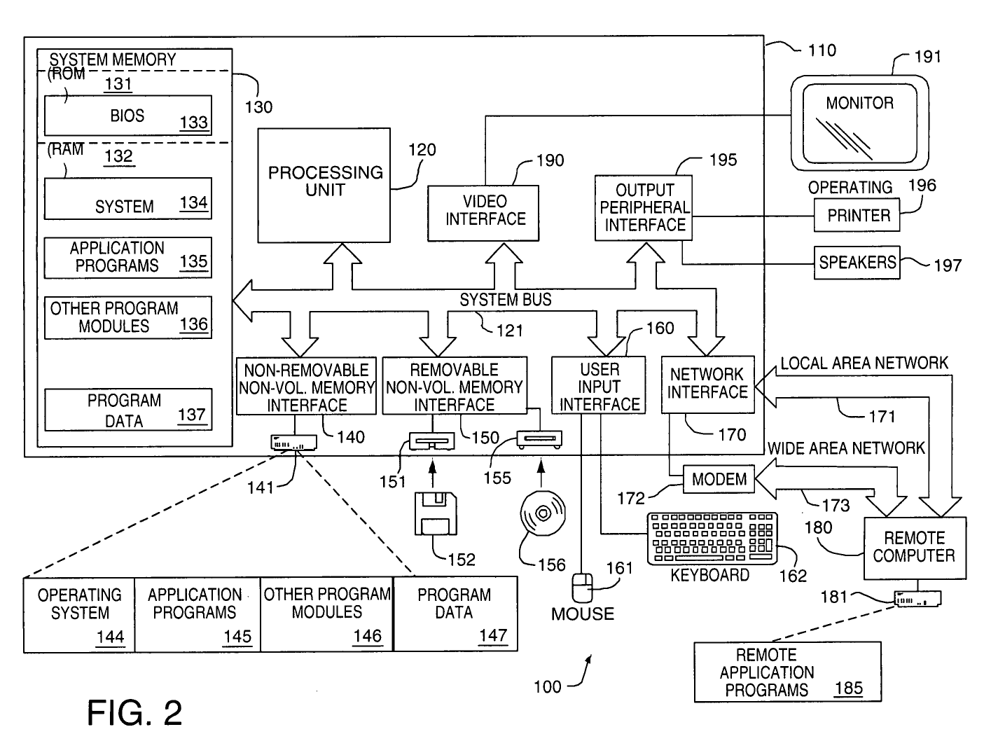

FIG. 2 illustrates an example of a suitable computing system environment 100 in which the cost redirection system may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 1 illustrates a client computer or local platform 10 having a cost redirection logon module 20. The user communicates over the network 40 with the remote cost redirection service 50. The user preferably has a relationship with a bill-paying entity that subscribes to the remote service 50. The local platform 10 also subscribes to the remote service and thus provides the logon dialog through the remote service 50.

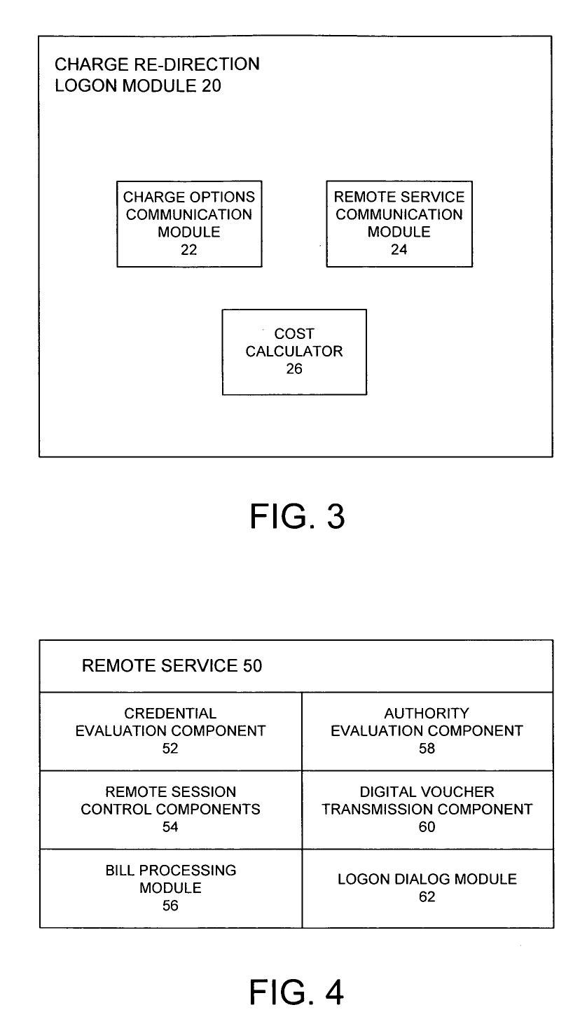

FIG. 3 illustrates the details of the charge redirection logon module 20 in accordance with an embodiment of the invention. The charge red-direction logon module 20 preferably includes a charge options communications module 22, a remote service communication module 24, and a cost calculator 26. These components help the logon module 20 interact with the remote service 50. The charge options communication module 22 provides a user with at least one charge redirection option. The remote service communication module 24 facilitates communication between the logon module 20 and the remote service 50. The cost calculator 26 calculates costs associated with consumption of user services.

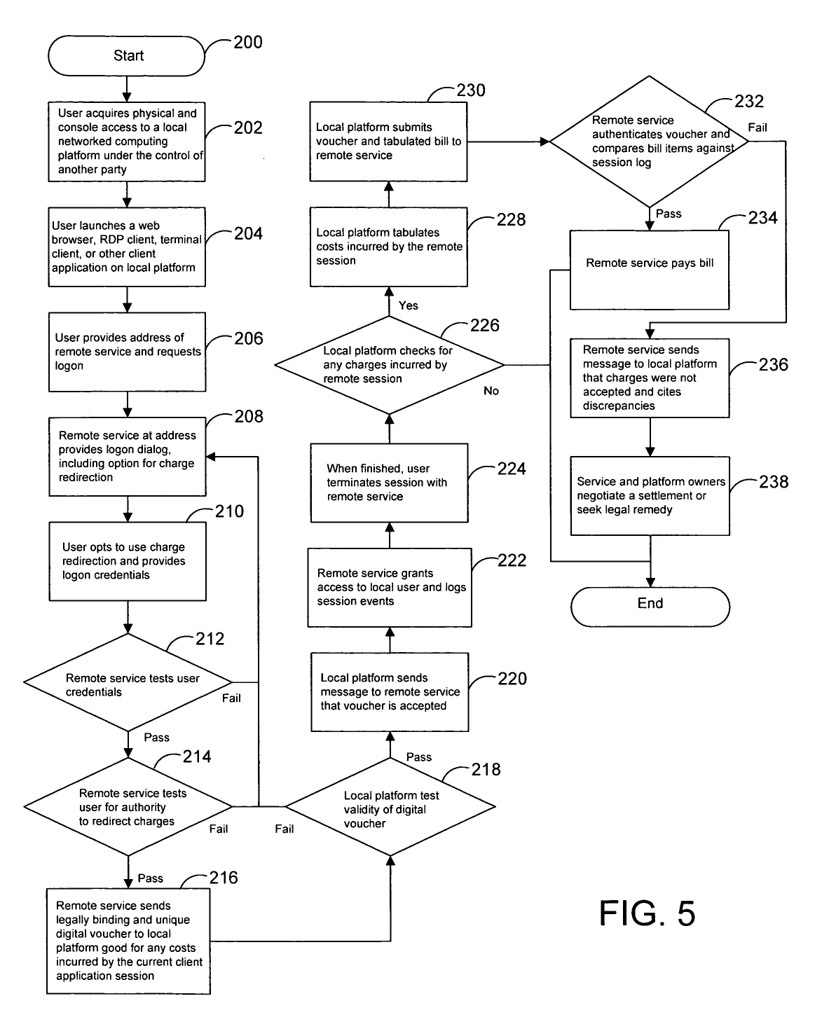

FIG. 4 illustrates the remote service 50 in accordance with an embodiment of the invention. The remote service 50 may include a credential evaluation component 52, remote session control components 54, a bill processing module 56, and an authority evaluation component 58. The remote service 50 may additionally include a digital voucher transmission component 60 and a logon dialog module 62. The credential evaluation component 52 receives and evaluates user credentials forwarded by the logon module 20. Remote session control components 54 may control the duration and nature of a remote session. The authority evaluation component 58 evaluates authority of a user to consume services and redirect billing. The digital voucher transmission component, upon verification of user credentials and authority, transmits a voucher to the local platform to ensure that charges will be covered. The logon dialog module 62 maintains a dialog with the logon module 20. The bill processing module 56 receives a bill from the local platform 10 and processes the bill. These features are further described below in conjunction with a method of the invention illustrated in FIG. 5.

FIG. 5 is a flow chart illustrating a process for redirecting charges in accordance with an embodiment of the invention. The process starts in step 200. In step 202, the user acquires access to a local networked computing platform 10 under the control of another party. In step 204, the user launches a web browser, remote desktop protocol (RDP) client, terminal client, or other client application on the local platform. In step 206, the user provides the address of the remote service and requests logon. In step 208, the remote service at the requested address provides a logon dialog including an option for charge redirection. In step 210, the user may opt to use charge redirection and provide credentials. In step 212, the remote service tests the entered credentials. If the credentials fail the test, the remote service may return to step 208 and restart the dialog. If the credentials pass the test, the remote service tests user authority to redirect charges. If the authority fails the test, the remote service may restart the logon dialog in step 208. If the authority passes the test, the remote service sends a unique digital voucher to the local platform in step 216. The unique digital voucher is provided to cover any costs incurred by the current client application session.

In step 218, the local platform tests the validity of the digital voucher. In step 220, the local platform sends a message to the remote service that the voucher is accepted. In step 222, the remote service grants access to the local user and logs the events of the session. In step 224, when the user is finished, the user terminates the session with the remote service. In step 226, the local platform checks for any charges incurred by the remote session. If charges are incurred, the local platform tabulates the charges incurred by the remote session in step 228. In step 230, the local platform submits the voucher and tabulated bill to the remote service. In step 232, the remote service authenticates the voucher and compares bill items against the session log. If the voucher is authenticated, the remote service pays the bill in step 234 and the process ends.

Alternatively, if the voucher is not authenticated in step 232, the remote service sends a message to the local platform that charges were not accepted in step 236. In step 238, the remote service and platform owners arrange a settlement.

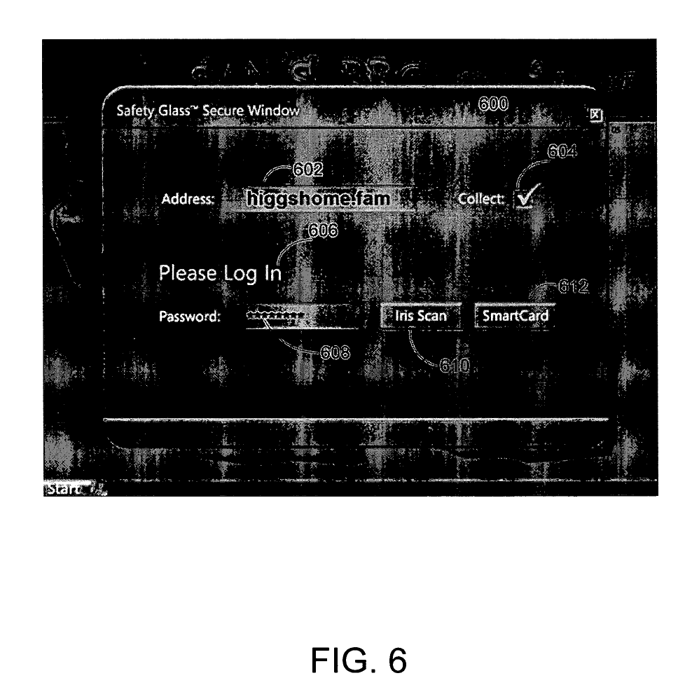

FIG. 6 is a screen shot 600 illustrating logon module dialog. The screen shot 600 includes an address 602 to which the user wants to connect. A “collect” box 604 allows a user to select charge redirection. A user login section 606 allows a user to enter a password 608. An iris scan option 610 or other mechanism may be available for authentication. A smart card option 612 provides a further authentication option. While these are examples of authentication options, other authentication options may also be used. Furthermore, these authentication options may be used separately, in combination, or in combination with other authentication options.

In summary, once the remote service receives the credentials and request for charge redirection, it evaluates the user credentials. If the user opts for collect logon, this desire is communicated along with the user's logon credentials through completion of the logon dialog. Once the remote service receives the credentials and request for charge redirection, it first evaluates the user credentials. If the credentials are deemed valid, then remote service checks for the user's authority to redirect the charges. If the authority is confirmed, a session to the remote service is opened and a legally binding unique digital voucher is transmitted to the owner of the local platform. The voucher is promise of payment for any incremental charges incurred during the course of the session.

At the close of the session, the local platform may tabulate any costs incurred as a result of the session and submits the voucher and an itemized bill back to the remote service. The remote service first authenticates the voucher, and then compares the bill to its own log of the session's events. If it determines that the bill is accurate, the remote service initiates payment, referencing the bill and voucher, to the owner of the local platform, or to whomever is cited as the payee on the submitted bill.

If there is a discrepancy between the bill and the remote services session log or the voucher is not successfully authenticated, the remote service may pay only undisputed charges or may withhold payment for all charges. Resolution of the matter may then be achieved through a negotiated settlement or by pursuing a legal remedy. Ultimately, in embodiments of the invention, a subscribing participant is charged for the service charges covered by the remote service.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A method for using a remote service for redirecting costs for use of computer services on a local platform, the method comprising:
receiving a user selection of a charge redirection option from the local platform;
transmitting a voucher to the local platform for a verified user, the voucher facilitating payment of costs for verified user charges associated with the verified user consumption of services for the local platform; and
receiving and processing a bill forwarded from the local platform for verified user consumption of services.

2. The method of claim 1, further comprising providing a logon dialog to enable the user of the local platform to select the charge redirection option.

3. The method of claim 1, further comprising verifying user credentials and transmitting the voucher if user credentials are verified.

4. The method of claim 1, further comprising tabulating incurred costs for user consumption of services at the local platform.

5. The method of claim 1, further comprising receiving a returned digital voucher and a bill for consumed user services.

6. The method of claim 5, further comprising authenticating the returned voucher.

7. The method of claim 6, further comprising paying the bill associated with the authenticated voucher.

8. A computer readable medium storing computer executable instructions for performing the method of claim 1.

9. A method for implementing a remote service for directing costs associated with use of a service offered through a local platform, the local platform including a logon module having a charge redirection option selectable by a local platform user, the method comprising:
receiving a user logon including selection of a charge redirection option;
processing user credentials using the remote service and transmitting a voucher from the remote service to the local platform if the user credentials are approved;
tabulating a cost for service usage from the local platform for the approved user and forwarding the cost to the remote service; and
authenticating the cost at the remote service and paying the cost from the remote service for the approved user if the cost is authenticated.

10. The method of claim 9, further comprising receiving a remote service address from the user.

11. The method of claim 9, further comprising providing a logon screen including a selectable charge redirection option for the user.

12. The method of claim 9, further comprising testing user authority to redirect charges.

13. The method of claim 9, wherein transmitting a voucher further comprises transmitting a unique digital voucher.

14. The method of claim 9, further comprising receiving a termination request from the user at the remote service in order to terminate a session.

15. A computer readable medium storing computer executable instructions for performing the method of claim 9.

16. A remote charge redirection system for enabling charge redirection for use of a service offered through a local platform, the local platform including a logon module having a charge redirection option selectable by a local platform user, the system comprising:
a logon dialog module for corresponding with the local platform to enable the local platform user to select a charge redirection option;
a digital voucher transmission component for transmitting a digital voucher from the remote charge redirection system to the local platform to facilitate redirection of charges; and
a bill processing module for processing a bill returned with the voucher from the local platform.

17. The system of claim 16, further comprising a credential evaluation component for verifying user credentials.

18. The system of claim 16, further comprising an authority evaluation component for evaluating user authority to redirect charges.

19. The system of claim 16, further comprising a bill processing module for receiving and processing a bill associated with the transmitted digital voucher.

20. The system of claim 16, further comprising a remote session control component for controlling the session with the local platform user.
